(19) United States
(12) Patent Application Publication
(10) Pub. No.: US 2020/0320632 A1
(43) Pub. Date: Oct. 8, 2020

(54) Method and system for time series data quality management

(71) Applicant: JPMorgan Chase Bank, N.A., New York, NY (US)

(72) Inventors: Luc Michel Teboul, Fair Lawn, NJ (US); Hari Moorthy, West Windsor, NJ (US)

(21) Appl. No.: 14/757,566

(22) Filed: Dec. 24, 2015

(51) Int. Cl. G06Q 40/06; G06F 17/30

(52) U.S. Cl. CPC G06Q 40/06; G06F 17/30554; G06F 17/3051

(57) ABSTRACT

According to an embodiment of the present invention, a system and method for implementing a time series management infrastructure comprises: a database that stores time series data from a plurality of internal and external sources; a rules engine that defines and executes one or more rules algorithms; and a computer processor, coupled to the database and the rules engine, programmed to: verify time series data from the plurality of internal and external sources; automatically identify outlier errors using an outlier detection algorithm based on a curve validation where a curve represents a series of date and point pairs; automatically correct the identified errors using one or more of: a gap filling technique and a back filling technique; and electronically transmit corresponding results to an interactive user interface.

### FIELD OF THE INVENTION

The present invention relates generally to a times series tool and more specifically to times series data quality management for risk calculations on a portfolio of financial exposures.

### BACKGROUND OF THE INVENTION

Value at Risk (VaR) is a statistical technique used to forecast an expected worst loss (e.g., at a specified probability) from a portfolio's distribution of market returns, based on a specific historical look back period. Value at Risk is commonly used by regulators of the financial industry in order to compare financial institutions and ensure that they are adequately capitalized. In general, VaR represents a risk measure of the risk of loss on a specific portfolio of financial exposures. VaR has four main uses in finance: risk management, financial control, financial reporting and computing regulatory capital.

Market returns are a critical input to the calculation. The ability to retrieve and store reliable and stable market returns is a necessary condition to produce reliable and accurate VaR numbers and perform other calculations. The complexity is an attribute of the size and the number of financial instruments. Generally, financial institutions provide details, including number of positions, different types of products and hence have to deal with wide range of finance instruments and very large volumes by all standards. However, in performing these critical calculations, some data points can be missing and returns are available starting after the beginning of the look back period. Other concerns include relying on incorrect data points (illiquid assets, etc.) and market returns that do not exist. Moreover, identifying issues and potentially erroneous data is a time consuming and difficult task.

Other drawbacks may also be present.

### SUMMARY OF THE INVENTION

Accordingly, one aspect of the invention is to address one or more of the drawbacks set forth above. According to an embodiment of the present invention, an automated computer implemented system for implementing a time series management infrastructure comprises: a database that stores time series data from a plurality of internal and external sources; a rules engine that defines and executes one or more rules algorithms; and a computer processor, coupled to the database and the rules engine, programmed to: verify time series data from the plurality of internal and external sources; automatically identify outlier errors using an outlier detection algorithm based on a curve validation where a curve represents a series of date and point pairs; automatically correct the identified errors using one or more of: a gap filling technique and a back filling technique; and electronically transmit corresponding results to an interactive user interface.

According to another embodiment of the present invention, an automated computer implemented method for implementing a time series management infrastructure, comprises the steps of: storing, in a database, time series data from a plurality of internal and external sources; executing, via a rules engine, one or more rules algorithms; verifying, via a programmed computer processor, time series data from the plurality of internal and external sources; automatically identifying, via the programmed computer processor, outlier errors using an outlier detection algorithm based on a curve validation where a curve represents a series of date and point pairs; automatically correcting, via the programmed computer processor, the identified errors using one or more of: a gap filling technique and a back filling technique; and electronically transmitting, via the programmed computer processor, corresponding results to an interactive user interface.

These and other embodiments and advantages of the invention will become apparent from the following detailed description, taken in conjunction with the accompanying drawings, illustrating by way of example the principles of the various exemplary embodiments.

### BRIEF DESCRIPTION OF THE DRAWINGS

In order to facilitate a fuller understanding of the present inventions, reference is now made to the appended drawings. These drawings should not be construed as limiting the present inventions, but are intended to be exemplary only.

FIG. 1 illustrates an exemplary system diagram, according to an embodiment of the present invention.

FIG. 2 is an exemplary user interface, according to an embodiment of the present invention.

FIG. 3 illustrates an exemplary onboarding workflow, according to an embodiment of the present invention.

FIG. 4 illustrates an exemplary update workflow, according to an embodiment of the present invention.

### DESCRIPTION OF EMBODIMENTS OF THE INVENTION

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

An embodiment of the present invention is directed to a strategic time series infrastructure that provides flexibility around time series and management of time series. The system automatically detects erroneous data points and automatically corrects corresponding issues. An embodiment of the present invention is directed to verifying accuracy of time series data from multiple sources, including external and internal sources. The system of an embodiment of the present invention may include at least two parts. A first part is directed to “outlier detection” that detects potential data issues. A second part is directed to a gap filling and a back filling procedure. Gap filling automatically calculates data points when a return is missing and back filling automatically calculates returns from the beginning of the look back period up to the point where valid returns are available. Other methodology for accounting for missing data points may be used. The ability to detect many different types of data issues while data is being acquired as well as a framework that automatically corrects data issues is a unique contribution to the industry.

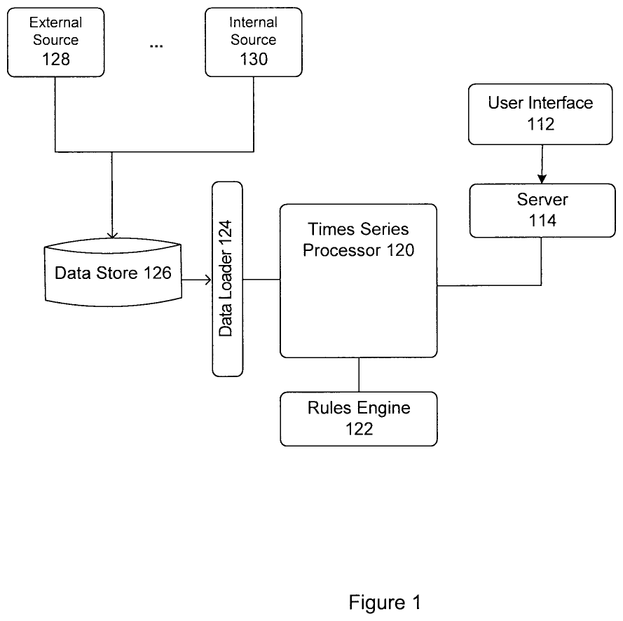

FIG. 1 is an exemplary time series data quality management system, according to an embodiment of the present invention. System 100 illustrates an exemplary implementation of a system of an embodiment of the present invention. A user may be authenticated and interact via User Interface or Portal 112. User Interface 112 may provide an interface for the user to interact with Server 114. Server 114 may interact with Time Series Processor 120 and Rule Engine 122. Data from External Source 128 and/or Internal Source 130 may be loaded via Data Loader 124. Time series data may be stored at Data Store 126. Time Series Processor 120 may perform validation of time series data, outlier detection, error management and correction functionality.

Rules Engine 122 may maintain and process various rules to detect potential data issues. Such rules may include an Impossible Values Rule, a Most Common Level Rule, a Missing Values Rule, a Volatility Rule, a Unique Levels Rule, a Filled Portion Rule, a Staleness Rule, a Recent History rule, and a Spike Rule. Other rules and variations may be applied.

An Impossible Values Rule determines that a time series is invalid if it has at least one non-positive value. For example, a single negative or zero value makes the entire Credit Default Swap (CDS) Spread time series invalid. Under this exemplary rule, time series may be presumed to be lognormal, such as equity prices. For example, there are time series that are allowed to have zero or negative values but at the same time use relative historical shocks. An exemplary time series may produce an astronomical VaR because of its enormous relative shocks on the days it was crossing zero.

A Most Common Level Rule decides a time series is invalid if the most common value appears more than 40% of the time; questionable if between 15% and 40%. Other ranges and/or percentages may be applied. For example, a time series 10, 11, 10, 12, 10, 9, 10, 8, 10, 11, . . . would be invalid because the most common level “10” appears 50% of the time. This may be performed either before filling the missing data or after; it is preferable to do it before the filling.

A Missing Values Rule determines that a time series is invalid if it has at least one missing value in a given historical window. For example, hVaR or historical VaR requires the last 360 points of a time series, if the time series value for the most recent date has not been set by the daily update process, that time series may be invalid for the purpose of hVaR calculation.

A Volatility Rule decides a time series is invalid if a standard deviation of daily shocks>50%; questionable if between 10% and 50%. Other ranges and/or percentages may be applied. For example, a relative time series 1, 2, 1, 2, 1, 2, . . . would be invalid based on the Volatility test. The same (or similar) thresholds may be used for equity prices. In general, the thresholds might differ by time series category and sub-category.

A Unique Levels Rule decides a time series is invalid if the total number of unique levels is less than 2.5% of the total number of observations; questionable if between 2.5% and 5%. For example, a time series 1, 2, 3, 4, 5, 1, 2, 3, 4, 5, . . . would be invalid for a 265-day window because it has five unique levels and 5/265=1.9%<2.5%. Other ranges and/or percentages may be applied.

A Filled Portion Rule determines that a time series is invalid if it is more than 90% filled; questionable if between 85% and 90%. For example, a weekly time series would have a filled portion of 80% and therefore pass the test. Other ranges and/or percentages may be applied.

A Staleness Rule determines that a time series is questionable if at least 80% of its shocks are equal to zero. For example, a time series that is flat every week day except, for example, Thursdays, would be questionable. A time series may not be deemed invalid based on failing the Staleness test. Other ranges and/or percentages may be applied.

A Recent History Rule determines that a time series is invalid if it has 10 or fewer observations in the last 60 days of history; questionable if between 10 and 20. For example, if a time series stopped having reported values, it will become questionable after about 2 months. Other ranges and/or percentages may be applied.

A Spike Rule determines that a time series is invalid if it has spike severity over 25; questionable if between 10 and 25. Other ranges and/or percentages may be applied. For example, the largest spike of a time series may be a 9 standard deviations move down followed by a 4 standard deviations move up. Spike Severity of the time series would be sqrt(9*4)=6, for example. Spike may be defined as a move in one direction immediately followed by a move in an opposite direction. Spike size may be the geometric average of the sizes of the two moves. The moves may be measured in units of standard deviations of daily moves for the given time series. Spike severity of a time series may be the size of its largest spike.

Other time series may include credit single name CDS, credit index spreads and volatility, Interest Rates and Foreign Exchange prices, basis and volatility, etc.

Another embodiment of the present invention may be directed to gapfilling and backfilling. This may involve automatically calculating a data point when a return is missing and may further involve automatically calculating returns from a beginning of a look back period up to the point when valid returns are added.

According to an embodiment of the present invention, a filling process may take place as a daily batch process (or other periodic time period), initiated once import, validation and consensus building jobs are complete. According to an exemplary application, the filling process may be split into three parts (in this example, the latter two may be driven by Quantitative Research groups logic). These modules may include: (1) determine the time series which have gaps; (2) generate an execution plan; and (3) perform the actual filling algorithm. For instance the filling algorithm may be designed to fill a value of the time series by taking the average of two other entries or by copying a value from another time series considered similar.

For example, gaps may occur: when the process fails to retrieve a raw data point from a source-system for a given EOD; when scrubs or corrections are made on a curve, then all fills on that curve (and associated dependent curves) may expire (e.g., essentially deleted); when the dependency graph changes, all fills on curves which have had a change in “parent” may expire; and when front-fills are proceeded by a new raw data point these may expire.

The execution plan may be based on a list of time series with gaps. The plan may specify: a list of groups of time series to be filled together; an order in which groups will be filled; transformations required to convert time series into (and back from) the space required by a filling algorithm; and other methodology requirements, such as whether volatility adjustment is needed or not. These requirements may not be static.

The actual filling algorithm may be based on the execution plan and return a vector containing tuples for al filled values (e.g., time series id, date, value, etc.). An embodiment of the present invention may take these values and save them into a versioned time series in a GapFilled stratum, for example.

An exemplary filling execution plan may include a master execution plan and a daily plan. An exemplary master execution plan may contain a reference to some, most or all curves maintained by an embodiment of the present invention. This may be represented as a dependency graph which may map sets of “child” curves (e.g., the set of curves to-be-filled) to another set of “parent” curves (e.g., a set of already-filled curves). An exemplary master execution plan may indicate that: time series 1 (TS1) and TS2 will be filled together in a group; in parallel, TS3 is filled on its own; following the filling of TS1 and TS2, TS4 and TS5 can be filled in a group together with the already-filled TS6.

A smaller execution plan (e.g., daily plan) may be created based on the master plan. For example, if an edit is made to TS5 (or there has been a front-fill expiry) then all the fills on TS4, TS5 and TS6 may need to be expired. Accordingly, the daily plan may indicate such. According to another example, a dependency change in the master plan may be such that TS4 and TS5 are now to be filled together with TS6. In this case, the fills of TS4, TS5 and TS6 will need to be expired and re-filled but the fills on the indices remain since their “parents” have not changed. The resulting daily execution plan may then capture the dependency change.

Time-travel examples may include invalidated front-fill; gap-filling with scrubbing; and gap-filling with correction. Another example may include bi-temporal issue.

An embodiment of the present invention is directed to a strategic time series infrastructure. An exemplary system provides flexibility around time series and management of time series. For example, time series data for VaR may be stored and made accessible thereby allowing non-destructive manual editing and filling of time series data; and further providing bi-temporal support for edits. Further, users may choose to “scrub” data on one timeline and “correct” data on another. This allows one type of edit to be applied while filtering out another.

An embodiment of the present invention allows integrated sandboxing and testing without needing to copy data. A framework of an embodiment of the present invention is directed to statistical analysis (e.g., outlier and validity detection) to review production time series data in an automated fashion and allows searching and filtering of time series based on metadata. For example, time series may be stored as levels, not returns.

An embodiment of the present invention supports multiple data sources for the same data and allows Quantitative Research groups to switch which source is official (used for VaR); transparency into the source of each data point (e.g., raw, edited, filled, etc.) and classification of the quality of the time series as a whole (e.g., valid, questionable, invalid, etc.).

According to an embodiment of the present invention, data may be sourced via “data loaders” which may have specific implementations for each source system and source type. According to an exemplary application, loaders may have the same (or similar) structure but use different keys and pipes. Also, data may be pulled from source systems rather than being pushed from source systems. For example, when historical data is missing, a curve may be backfilled from a different data source, seamlessly to the consumer.

According to an embodiment of the present invention, a point may represent a single value for a given date, e.g., stock price on Oct. 5, 2015. A curve may represent a series of pairs (e.g., date, Point), e.g., stock price history for 2015. A Time Series Identifier may represent a series of related Curves, e.g., credit spreads. An Element may represent one curve component of a Time Series Identifier, e.g., 3 m tenor. A Shape may represent a list of Elements in a Time Series Identifier. A Statum may represent a data layer. For example, strata are independent and stack to create an official time series for VaR.

Data may be pulled from various sources. An embodiment of the present invention recognizes that not all source systems provide historical download and oftentimes, only recent data points are available. Data sources may provide data in various formats, including curves, points. Other data may include bond basis, credit index, credit index volatility, credit single name, Foreign Exchange at the money volatility, Foreign Exchange Butterfly Volatility, Foreign Exchange Risk Reversal Volatility, Foreign Exchange spot, Interest Rates Basis, Interest Rates Benchmark swap rate, and IR OIS basis.

Access to an embodiment of the present invention may occur through a Portal or other interface, which may be a programmatic interface that a user can access using a programing language. It allows other applications to leverage the time series infrastructure. For example, the interface may take several arguments: the instance, the start and end dates of the time series, as well as other argument which allows to extract the relevant data points.

An embodiment of the present invention is directed to the ability for a user to modify time series in a sandbox without altering the data used by the VaR calculation. This functionality provides the ability to experiment and perform analysis in order to find out how to manage certain anomalies in the time series.

An embodiment of the present invention is directed to a framework for validation and outlier detection rules. For example, validation failures (e.g., Impossible Values) may result in points and be automatically removed from the time series. In addition, outlier detection failures result in workflow actions.

The workflow framework of an embodiment of the present invention may be generic and extensible. Workflows may be defined by fundamental building blocks.

For example, time series data may be controlled by a single entitlement, e.g., TimeSeriesData. According to an exemplary embodiment, users do not have direct access to write to the time series and accordingly, may go through a pre-defined workflow to perform changes.

Workflow configuration may be controlled by entitlements, where users outside of a core team may not be entitled to make changes. For example, workflow items (e.g., requests) may be inserted and read by anyone, but once inserted may only be changed by an authorized user. Changes to entitlements and permissions may be controlled through a standard entitlement infrastructure and changes to the entitlements on an object may trigger a notification.

Exemplary workflows may include curve on-boarding; curve update; outlier detection and curve validation. Curve on-boarding may be used when a new curve to be loaded for VaR is identified. Addition of the curve does not immediately make it available for VaR, rather Quantitative Research, for example, may explicitly enable it.

Curve update may be used for scrubbing and correcting curve points; and may further include approval and review chain. Also, notifications may be included if desired. For example, when data is scrubbed, a point may be added to a versioned time series in the edits stratum (e.g., scrubs time series). For example, if an “entryTimeCutoff” parameter on a portal of an embodiment of the present invention is then set back in time, a previous version of this data may be accessed. When data is corrected, a point may be added to a second versioned time series in the edits stratum (e.g., corrections time series). For example, if a “correctionTimeCutoff” parameter on the portal is then set back in time, a previous version of this data may be accessed. Accordingly, the time series that is read out of the edits stratum may then be a combination of these two time series. Where there is clash of EOD values, the newer point (e.g., whether a scrub or a correction) takes precedence. For example, raw stratum (and other strata and metadata) may be accessed using the entry time cutoff. An exemplary use case may involve rewind entryTimeCutoff and correctionTimeCutoff together to reproduce results for a previous day. Another exemplary use case may include rewind entryTimeCutoff only in order to get corrected results for a previous day.

Outlier detection may be applied automatically or periodically. For example, outlier detection may be automatically closed (with no action) after a number of days.

According to an exemplary embodiment, a liquid list of curves which are required by downstream processes may be maintained. Curves in the liquid list may be monitored using outlier detention and breaks may be flagged to be scrubbed. If invalid data is identified for curves not on the liquid list, the invalid data may be stored and not flagged for scrubbing. If a curve needs to move onto the liquid list, it may be scrubbed and filled.

Curve validation may be applied automatically, e.g., when an overnight validation detects a theoretically impossible value on a curve. A workflow engine may identify this and automatically remove the point. An embodiment of the present invention provides transitions of curves due to validation. For example, a cached score may represent the last score run for a pair (e.g., curve, validationfunc). If a user has reviewed an item, the cached value may be frozen at the value which was reviewed. If a previously frozen cached score improves into the VALID region, it may become unfrozen. The scores are continuous values between 0% and 100%. In addition, bands of INVALID, SUSPECT, VALID may be specified. Bands may be different for different types, or bands may be normalized. When more than one score is created for a given curve (e.g., multiple tests, etc.), any test which triggers a downgrade may downgrade the curve, but if all tests trigger an upgrade, the upgrade will occur.

An embodiment of the present invention may also extend synthetic/dynamic time series for new use cases and may further provide automated handling of stock splits for equities.

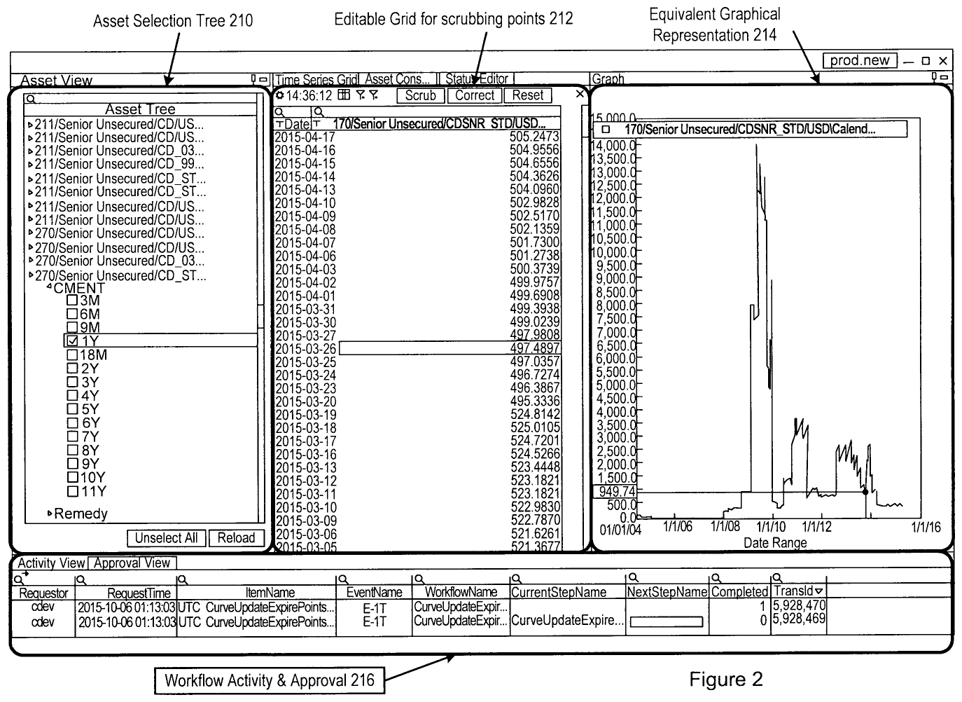

FIG. 2 is an exemplary user interface, according to an embodiment of the present invention. The user interface comprises a plurality of sections, which may include Asset Selection Tree 210, Editable Grid for scrubbing points 212, Equivalent Graphical Representation 214 and a Workflow Activity and Approval section 216. The Workflow Activity may provide visibility into manual changes and ensure that these changes are approved by the appropriate group before they can be used in the VaR calculation. Editable Grid 112 may display a time series grid, asset constructor, status editor, etc. Equivalent Graphical Representation 114 may compare time series along a date range. Workflow Activity and Approval section 116 may display an activity view and an approval view. Activity view may display requestor, request time, item name, event name, workflow name, current step name, next step name, completed and transaction identifier.

The interface may also provide improved auditing of changes, e.g., visualizations and proactive notifications of changes to data and configurations. Other interface features may include viewing of outlier and validation errors; suppression of certain outliers; editing of metadata and searching of curves based on metadata.

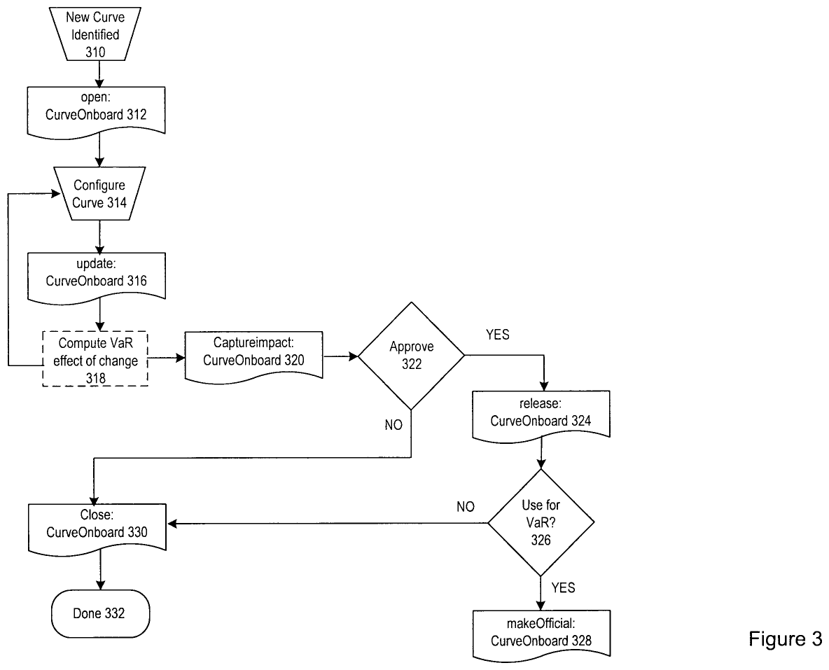

FIG. 3 illustrates an exemplary onboarding workflow, according to an embodiment of the present invention. At step 310, a new curve is identified. At step 312, a curve onboard is opened. At step 314, the curve may be configured. At step 316, the curve onboard is updated. At step 318, VaR effect of change is computed. At step 320, capture impact may be performed. Step 322 may determine approval. If not approved, curve onboard may be closed step 330. If approved, curve onboard may be released at step 324. For example, a curve may exist in production but may not be accessed for VaR. Step 326 determines whether VaR is used. If yes, step 328 makes official curve onboard. Step 330 closes curve onboard and the process is completed at step 332. The order illustrated in FIG. 3 is merely exemplary. While the process of FIG. 3 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

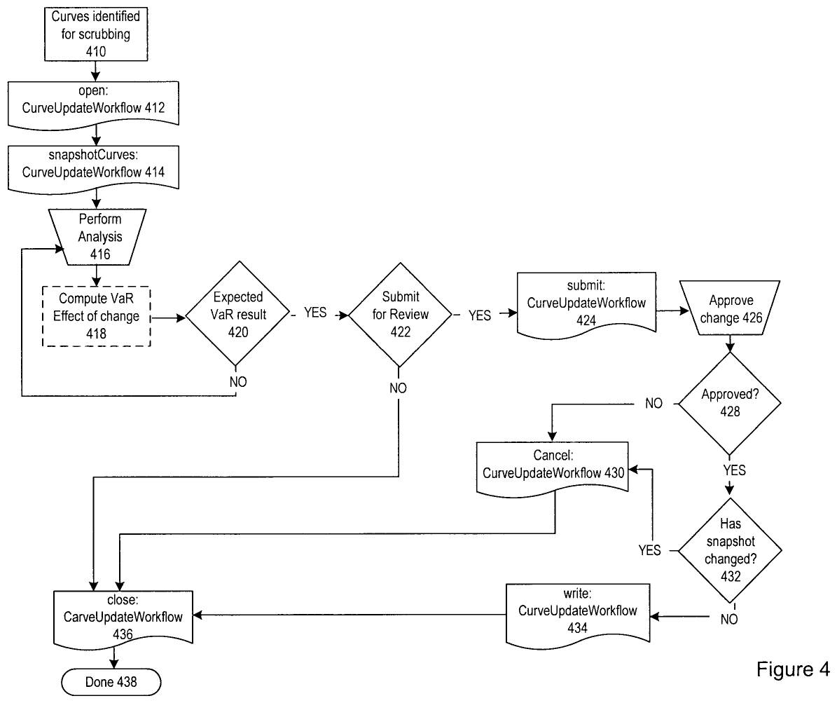

FIG. 4 illustrates an exemplary update workflow, according to an embodiment of the present invention. At step 410, a new curve is identified for scrubbing. At step 412, a curve update workflow is opened. At step 414, snapshot curve update workload is identified. At step 416, analysis may be performed. At step 418, VaR effect of change is computed. Step 420 determines an expected VaR result is received. If no, analysis is performed at step 416. If yes, submit for review at 422. If not reviewed, curve update workflow is closed at 436. If approved for review, curve update workload is submitted at 424. At step 426, any changes may be approved. Step 428 determines whether change is approved. If not, curve update workflow is cancelled at 430. If approved, step 432 determines whether snapshot has changed. If not, write curve update workflow at step 434. If changed, curve update workflow is cancelled at 430. At step 436, curve update workflow is closed and the process is completed at step 438. The order illustrated in FIG. 4 is merely exemplary. While the process of FIG. 4 illustrates certain steps performed in a particular order, it should be understood that the embodiments of the present invention may be practiced by adding one or more steps to the processes, omitting steps within the processes and/or altering the order in which one or more steps are performed. These steps will be described in greater detail below.

While the exemplary embodiments described herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Data and information maintained by a Processor may be stored and cataloged in a Database which may comprise or interface with a searchable database. The database may comprise, include or interface to a relational database. Other databases, such as a query format database, a Standard Query Language (SQL) format database, a storage area network (SAN), or another similar data storage device, query format, platform or resource may be used. The database may comprise a single database or a collection of databases, dedicated or otherwise. In one embodiment, the database may store or cooperate with other databases to store the various data and information described herein. In some embodiments, the database may comprise a file management system, program or application for storing and maintaining data and information used or generated by the various features and functions of the systems and methods described herein. In some embodiments, the database may store, maintain and permit access to participant information, transaction information, account information, and general information used to process transactions as described herein. In some embodiments, the database is connected directly to the Processor, which, in some embodiments, it is accessible through a network, such as a communication network, for example.

Communications network may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection.

Communications network may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 107 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network may comprise a satellite communications network, such as a direct broadcast communication system (DBS) having the requisite number of dishes, satellites and transmitter/receiver boxes, for example. Communications network may also comprise a telephone communications network, such as the Public Switched Telephone Network (PSTN). In another embodiment, communication network may comprise a Personal Branch Exchange (PBX), which may further connect to the PSTN.

In some embodiments, the processor may include any terminal (e.g., a typical home or personal computer system, telephone, personal digital assistant (PDA) or other like device) whereby a user may interact with a network, such as communications network, for example, that is responsible for transmitting and delivering data and information used by the various systems and methods described herein. The processor may include, for instance, a personal or laptop computer, a telephone, or PDA. The processor may include a microprocessor, a microcontroller or other general or special purpose device operating under programmed control. The processor may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. The processor may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). The processor may also include a network-enabled appliance, a browser-equipped or other network-enabled cellular telephone, or another TCP/IP client or other device.

The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example. As described herein, a module performing functionality may comprise a processor and vice-versa.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; e.g., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Further, although the embodiments of the present inventions have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein.

1. A system that implements a time series management infrastructure comprising:
a database that stores time series data from a plurality of internal and external sources;
a rules engine that defines and executes one or more rules algorithms to detect potentially invalid data, the one or more rules algorithms including at least one of an Impossible Values Rule, a Most Common Level Rule, a Missing Values Rule, a Volatility Rule, a Unique Levels Rule, a Filled Portion Rule, a Staleness Rule, a Recent History rule, and a Spike Rule; and
a computer processor, coupled to the database and the rules engine, programmed to:
source time series data, via data loaders, from one or more internal and external source systems, wherein the data loader are specific for each of the one or more source systems;
verify the sourced time series data is complete by implementing the Missing Values Rule, wherein the Missing Values Rule determines if there are any missing data points for a specified historical data window;
upon detection of one or more missing data points in the time series data, automatically correct the time series data through:
(1) a gap filling technique, wherein the gap filling technique first searches for missing data points from a plurality of alternate online sources and fills the missing data points with the data from the alternate online sources, and second should alternate online sources be unavailable, calculate the missing data points; and
(2) a back filling technique, wherein the backfilling technique automatically calculates market returns from the beginning of the historical data window to the point where valid market returns are available;
wherein the gap filling technique and the back filling technique return a vector containing tuples comprising at least a date and a value for each missing data point;
execute the one or more rules algorithms on the corrected time series data to identify outlier errors, wherein the outliers are determined by one or more of:
(1) a determination that a value has a negative value;
(2) a determination that a particular value appears in more than 40% of the time series data points;
(3) a determination that a value leads to the time series data having a spike severity over 25;
automatically correct the identified outlier errors using data scrubbing; and
electronically transmit, via a communication network, corresponding results to an interactive user interface, wherein the interactive user interface comprises an asset selection tree section; an editable grid for scrubbing points section; a graphical representation section that compares time series along a predetermined date range; and a workflow activity and approval section that provides visibility into manual changes and change approvals.

2. The system of claim 1, wherein the one or more rules algorithms comprises an Impossible Value Rule that determines that a time series is invalid if it has one non-positive value.

3. The system of claim 1, wherein the one or more rules algorithms comprises a most common level rule that decides a time series to be invalid if a most common value appears more than a predetermined percentage of time.

4. The system of claim 1, wherein the one or more rules algorithms comprises a missing values rule that determines that a time series if invalid if it has at least one missing value in a predetermined historical window.

5. The system of claim 1, wherein the one or more rules algorithms comprises a spike rule that determines that a time series is invalid if it has spike severity over a predetermined range.

6. (canceled)

7. (canceled)

8. The system of claim 1, wherein the computer processor is further programmed to calculate a value at risk calculation based on the results for a portfolio.

9. (canceled)

10. The system of claim 1, wherein the workflow activity and approval section further ensures that changes are approved by an appropriate group prior to being used in a VaR calculation.

11. An automated computer implemented method for implementing a time series management infrastructure, wherein the method comprising the steps of:
storing, in a database, time series data from a plurality of internal and external sources;
executing, via a rules engine, one or more rules algorithms to detect potentially invalid data, the one or more rules algorithms including at least one of an Impossible Values Rule, a Most Common Level Rule, a Missing Values Rule, a Volatility Rule, a Unique Levels Rule, a Filled Portion Rule, a Staleness Rule, a Recent History rule, and a Spike Rule;
sourcing time series data, via data loaders, from one or more internal and external source systems, wherein the data loader are specific for each of the one or more source systems;
verifying the sourced time series data is complete by implementing the Missing Values Rule, wherein the Missing Values Rule determines if there are any missing data points for a specified historical data window;
upon detection of one or more missing data points in the time series data, automatically correcting the time series data through:
(1) a gap filling technique, wherein the gap filling technique first searches for missing data points from a plurality of alternate online sources and fills the missing data points with the data from the alternate online sources, and second should alternate online sources be unavailable, calculate the missing data points;
(2) a back filling technique, wherein the backfilling technique automatically calculates market returns from the beginning of the historical data window to the point where valid market returns are available; and
wherein the gap filling technique and the back filling technique return a vector containing tuples comprising at least a date and a value for each missing data point;
executing, via the programmed computer processor, the one or more rules on the corrected time series data to identify outlier errors, wherein the outliers are determined by one or more of:
(1) a determination that a value has a negative value;
(2) a determination that a particular value appears in more than 40% of the time series data points;
(3) a determination that a value leads to the time series data having a spike severity over 25;
automatically correcting, via the programmed computer processor, the identified outlier errors using data scrubbing; and
electronically transmitting, via a communication network, corresponding results to an interactive user interface, wherein the interactive user interface comprises an asset selection tree section; an editable grid for scrubbing points section; a graphical representation section that compares time series along a predetermined date range; and a workflow activity and approval section that provides visibility into manual changes and change approvals.

12. The method of claim 11, wherein the one or more rules algorithms comprises an Impossible Value Rule that determines that a time series is invalid if it has one non-positive value.

13. The method of claim 11, wherein the one or more rules algorithms comprises a most common level rule that decides a time series to be invalid if a most common value appears more than a predetermined percentage of time.

14. The method of claim 11, wherein the one or more rules algorithms comprises a missing values rule that determines that a time series if invalid if it has at least one missing value in a predetermined historical window.

15. The method of claim 11, wherein the one or more rules algorithms comprises a spike rule that determines that a time series is invalid if it has spike severity over a predetermined range.

16. (canceled)

17. (canceled)

18. The method of claim 11, wherein the computer processor is further programmed to calculate a value at risk calculation based on the results for a portfolio.

19. (canceled)

20. The method of claim 11, wherein the workflow activity and approval section further ensures that changes are approved by an appropriate group prior to being used in a VaR calculation.
